(19) United States
(12) Patent Application Publication
(10) Pub. No.: US 2005/0066491 A1
(43) Pub. Date: Mar. 31, 2005

(54) Multi-shaft rotary creel, sample warper and warping method

(76) Inventors: Yoshihiro Tanaka, Kiryu-shi (JP); Takatsugu Aihara, Kiryu-shi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/938,632

(22) Filed: Sep. 13, 2004

(30) Foreign Application Priority Data
Sep. 26, 2003 (JP) 2003-334599
Dec. 12, 2003 (JP) 2003-415455

(51) Int. Cl. C08G 69/02; D03D 15/00; D02H 7/00

(52) U.S. Cl. 28/184

(57) ABSTRACT

There is provided a multi-shaft rotary creel where the degree of freedom for warping can be further improved as compared with the conventional single shaft rotary creel and occurrence of tension fluctuations can be prevented. There are further provided a sample warper and a warping method where warping can be performed efficiently by installing the multi-shaft rotary creel. The multi-shaft rotary creel comprises: a base body; a main shaft rotatably mounted on the base body so as to project forward, a plurality of supporting shafts rotatably mounted on a forward projecting portion of the main shaft; and a plurality of bobbins mountable on each of the supporting shafts, which is installed opposing to a sample warper with a plurality of yarn guides, and wherein, while the main shaft or each of the supporting shafts rotates in synchronism with rotation of the yarn guides, simultaneous warping of plural yarns by the main shaft or each of the supporting shafts can be performed.

### BACKGROUND OF THE INVENTION

1. Field of the Invention

The present invention relates to a multi-shaft rotary creel suitably used for a sample warper which is provided with a plurality of yarn guides for winding yarns on a warper drum and automatically exchanges yarns in preset pattern data (a preset yarn order) to wind yarns on the warper drum, a sample warper provided with the multi-shaft rotary creel and a warping method.

2. Description of the Related Art

As a sample warper used conventionally, there has been known, for example, a structure disclosed in Japanese Patent No. 1529104, namely a structure, wherein using a fixed creel for supporting a plurality of bobbins on which different kinds (different colors or twisted differently) of yarns are to be wound, the yarns are successively wound on a warper drum by yarn guides while yarn exchanging is performed by a yarn selection device according to preset pattern data (a preset yarn order).

Further, there has been also known a sample warper for winding a plurality of yarns simultaneously, wherein using a rotary creel and omitting a yarn exchanging step, it is possible to cancel loss of time for yarn exchanging, to wind simultaneously a plurality of yarns on a warper drum, and further to reduce a warping time (refer to Japanese Patent No. 1767706, U.S. Pat. No. 4,972,662 and EP375480).

The fixed creel has a plurality of bobbins on which the same kind and/or of different kinds (mainly different kinds) of yarns are to be wound, wherein since yarns can be warped for each yarn while yarn exchanging is freely performed by the selection device, a warping operation for pattern warping can be advantageously performed, but since yarns are sequentially wound on the warper drum for each yarn, much time is disadvantageously required for a warping operation. On the other hand, the rotary creel has a plurality of bobbins on which the same kind and/or different kinds of yarns are to be wound, and it can be applied to repetition warping for an extremely limited number of patterns such as solid color warping (for example, one color of a red color yarn), one to one warping (for example, repetition of one red yarn and one white yarn, or repetition of one S-twisted yarn and one Z-twisted yarn), two to two warping (for example, repetition of two red yarns and two white yarns, or two S-twisted yarns and two Z-twisted yarns) and the like. In the rotary creel, a warping operation of pattern warping except for the extremely limited number of patterns can not be disadvantageously performed but a warping time can be advantageously reduced to a great extent because the plural yarns are wound on the warper drum simultaneously.

The present applicant has already proposed a sample warper provided with a plurality of yarn selection devices corresponding to a fixed creel and a rotary creel, which can perform jointly pattern warping and repetition warping and reduce a warping time of a warping operation requiring solid color warping and pattern warping to achieve an extremely high efficiency (refer to JP2000-136456A and EP933455A2).

Further, the present applicant has also proposed a sample warper, wherein a plurality of rotary creel are combined to freely perform the pattern warping and the repetition warping (JP2002-339183A).

In the above-described sample warper with the rotary creel, improvement has been conducted aiming at how to reduce a warping time by effectively utilizing an advantage of the rotary creel that allows feeding a plurality of yarns simultaneously.

On the other hand, there has also been proposed a sample warper without a yarn selection device, wherein yarns are wound on a warper drum by performing yarn winding and suspension thereof alternately (refer to Japanese Patent No. 3263050 and JP2002-212851A).

In the sample warper described in JP2002-339183A, wherein a plurality of rotary creels are combined on a plane to allow performing freely pattern warping and repetition warping, since there are positional differences between the warper drum and the respective rotary creels, distances or angles between the bobbins and the distal end guide portions of the yarn guides become uneven according to a rotary creel to be used. For this reason, tension of yarns that are drawn out from the bobbins and wound on the warper drum via the distal end guide portions of the yarn guides become uneven, tension fluctuations being generated.

### SUMMARY OF THE INVENTION

The present inventors have reached the present invention as a result of the repeated researches for developing a rotary creel with a novel mechanism, which has solved the above-described problem.

An object of the present invention is to provide a novel multi-shaft rotary creel where the degree of freedom for warping is further improved as compared with the conventional single shaft rotary creel and generation of tension fluctuations can be prevented, a sample warper with the multi-shaft rotary creel capable of efficient warping and a warping method

A multi-shaft rotary creel according to the present invention comprises: a base body; a main shaft rotatably mounted on the base body so as to project forward; a plurality of supporting shafts rotatably mounted on a forward projecting portion of the main shaft; and a plurality of bobbins mountable on each of the supporting shafts, which is installed opposing to a sample warper with a plurality of yarn guides, and wherein, while the main shaft or each of the supporting shafts rotates in synchronism with rotation of the yarn guides, simultaneous warping of plural yarns by the main shaft or each of the supporting shafts can be performed. The multi-shaft rotary creel according to the present invention may preferably comprise further a driving unit for performing rotation and suspension of the main shaft and each of the supporting shafts and serving to keep suspended positions thereof.

One aspect of a sample warper according to the present invention comprises: a warper drum; and a plurality of yarn guides each rotatably mounted on a side surface of the warper drum for winding yarns on the warper drum, wherein yarns are wound on the warper drum according to a preset yarn order, and wherein there is installed the multi-shaft rotary creel according to the present invention having a plurality of bobbins on which different kinds and/or the same kind of yarns have been wound.

Another aspect of a sample warper according to the present invention comprises: a warper drum; and a plurality of yarn guides each rotatably mounted on a side surface of the warper drum for winding yarns on the warper drum, a yarn selection device for rotary creel provided with a plurality of yarn selection guides which are in correspondence with the yarn guides, each of the yarn selection guides being pivotally moved to a yarn exchanging position when exchanging yarns and retract to a standby position when storing yarns, wherein yarns are automatically exchanged and successively wound on the warper drum according to a preset yarn order by passing the yarns between the yarn guides and the yarn selection guides, and wherein the multi-shaft rotary creel according to the present invention having a plurality of bobbins on which different kinds and/or the same kind of yarns have been wound is installed in correspondence with the yarn selection device.

According to the above-described structure, the following warping modes (1) to (3) will be made possible.

(1) Simultaneous warping of a plurality of yarns is performed using all bobbins under the following conditions. The main shaft is rotated in synchronism with rotation of the yarn guides of the sample warper and each of the supporting shafts is rotated to positions such that the guide plates form a shape approximating to a circle shown in FIG. 3, and then suspended at the positions, the suspended state of each of the supporting shafts being kept. All bobbins mounted on the suspended supporting shafts are used for warping.

(2) Simultaneous warping of a plurality of yarns using a plurality of bobbins mounted on one of the supporting shafts is performed under the following conditions. The only one supporting shaft is rotated in synchronism with rotation of the yarn guides for warping. The plural bobbins mounted on the rotating supporting shaft are only used for warping.

(3) Single yarn warping is performed using any one of bobbins of the multi-shaft rotary creel under the following conditions. The main shaft and each of the supporting shafts are suspended and the suspended states are kept. Any one of the bobbins mounted on the suspended supporting shafts is only used for warping.

The warping modes (1), (2) and (3) are preferably applied to a sample warper without a yarn selection device, but a sample warper with a yarn selection device mounted below the center line of the warper drum is desirably applied with the following warping modes (2′) and (3′) in addition to the above mode (1).

(2′) Simultaneous warping of a plurality of yarns is performed using a plurality of bobbins mounted on one of the supporting shafts under the following conditions. The one supporting shaft to be used for warping is moved to a close position vertically above an extension line of the center position of a front face of the warper drum by rotating the main shaft, then suspended at the position and the suspended state of the supporting shaft is kept, the supporting shaft being rotated in synchronism with rotation of the yarn guides of the sample warper, and the remaining supporting shafts are rotated to positions such that guide plates become approximately horizontal as shown in FIG. 4, and then suspended at the positions, the suspended state of each of the remaining supporting shafts being kept.

(3′) Single yarn warping is performed using one bobbin under the following conditions. The main shaft is rotated such that a supporting shaft which supports the bobbin to be used for warping is positioned at a close position vertically above an extension line of the center position of the front face of the warper drum, then suspended at the position and the suspended state of the main shaft is kept, and next after the supporting shaft is rotated such that a bobbin to be used for warping is positioned at the highest position, the suspended state of each of all the supporting shafts is kept.

By performing warping according to the warping modes (1), (2) and (3), or (1), (2′) and (3′), warping is made possible with less tension fluctuations among the respective yarns. A warping method according to the present invention using the sample warper of the present invention is characterized in that there is performed simultaneous warping of a plurality of yarns using all the bobbins, simultaneous warping of a plurality of yarns using a plurality of bobbins mounted on one supporting shaft or a single yarn warping of one yarn using one bobbin.

According to the multi-shaft rotary creel of the present invention, such an advantage is achieved that the degree of freedom for warping can be further improved as compared with the conventional single shaft rotary creel, and occurrence of tension fluctuations can be prevented. Further, the sample warper of the present invention is capable of warping efficiently by installing the multi-shaft rotary creel.

### BRIEF DESCRIPTION OF THE DRAWINGS

FIG. 1 is a schematic explanatory perspective view showing an embodiment of the sample warper of the present invention;

FIG. 2 is an explanatory side view showing a structural example of the multi-shaft rotary creel of the present invention;

FIG. 3 is an explanatory front view of the multi-shaft rotary creel shown in FIG. 2; and

FIG. 4 is an explanatory front view showing a state that yarns have been pulled out from bobbins held by respective bobbin holders of the multi-shaft rotary creel.

### DETAILED DESCRIPTION OF THE INVENTION

An embodiment of the present invention will be explained below with reference to the attached drawings. The embodiment described herein is illustrative, and it may be modified variously without departing from the scope and spirit of the present invention.

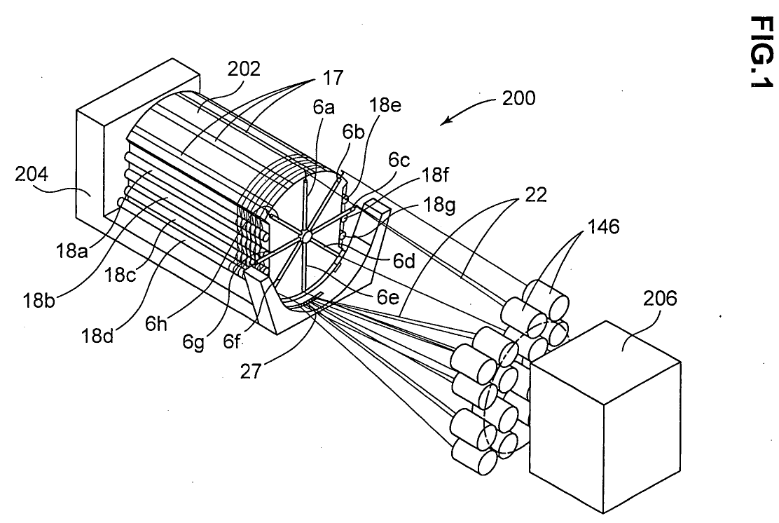

In FIG. 1, a sample warper 200 of the present invention comprises: a warper drum 202; and a plurality of yarn guides 6a to 6h (in this illustrated example, the number of the yarn guides is eight, but actually yarn guides of the same number as the total number of bobbins are used, for example, if the number of bobbins is sixteen, the number of yarn guides is sixteen) each rotatably mounted on a side surface of the warper drum 202 for winding yarns 22 on the warper drum 202, a yarn selection device 27 for a rotary creel provided with a plurality of yarn selection guides which are in correspondence with the yarn guides, each of the yarn selection guides being pivotally moved to a yarn exchanging position when exchanging yarns and retract to a standby position when storing yarns; and a multi-shaft rotary creel 206 having a plurality of bobbins 146 on which different kinds and/or the same kind of yarns 22 have been wound and installed in correspondence with the yarn selection device 27, wherein yarns 22 are automatically exchanged and successively wound on the warper drum 202 according to a preset yarn order by passing the yarns 22 between the yarn guides 6a to 6h and the yarn selection guides of the yarn selection device 27. Incidentally, the basic structure and function of the sample warper 200 are broadly known from the above-described patent documents and the like, and detailed explanation thereof will be omitted.

Reference numeral 17 denotes a conveyor belt movably mounted on a circumferential surface of the warper drum 202. A feed rate of the conveyor belt 17 is controlled by a conveyor belt feed unit in accordance with warping conditions (the number of warping yarns, a warping width, the winding number of warping yarns and the like). The movement of the conveyor belt 17 is synchronized with rotation of the yarn guides 6a to 6h. Reference numerals 18a to 18g denote shedding bars. Distal end portion of the shedding bars 18a to 18g on the yarn guide side are provided with shedding units for forming a shed of the yarns 22.

In this connection, as the yarn selection device 27, there can be used a conventional one, for example, one described in JP2002-339183A.

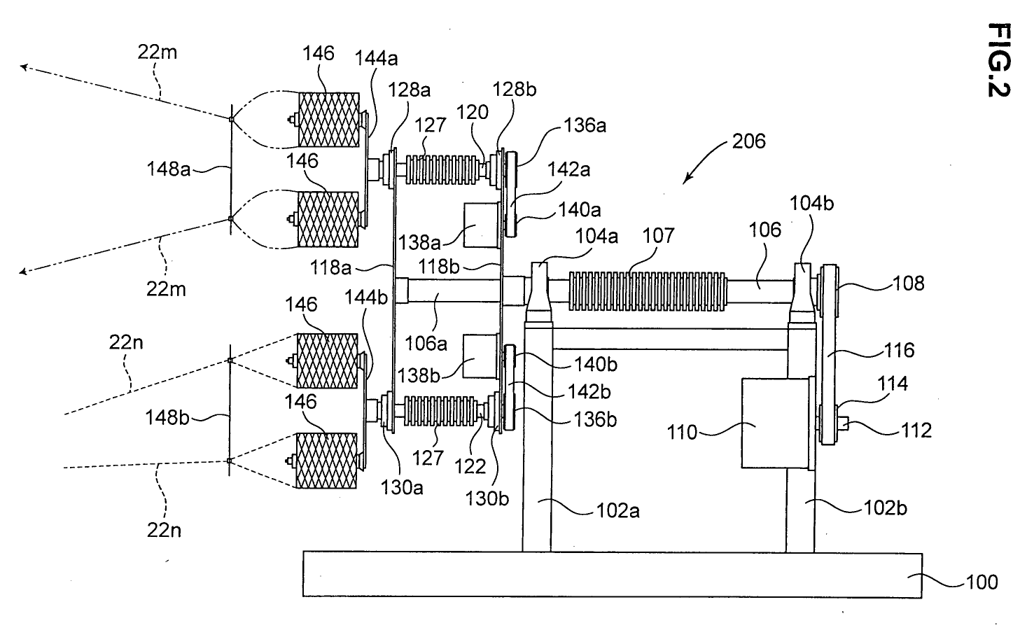

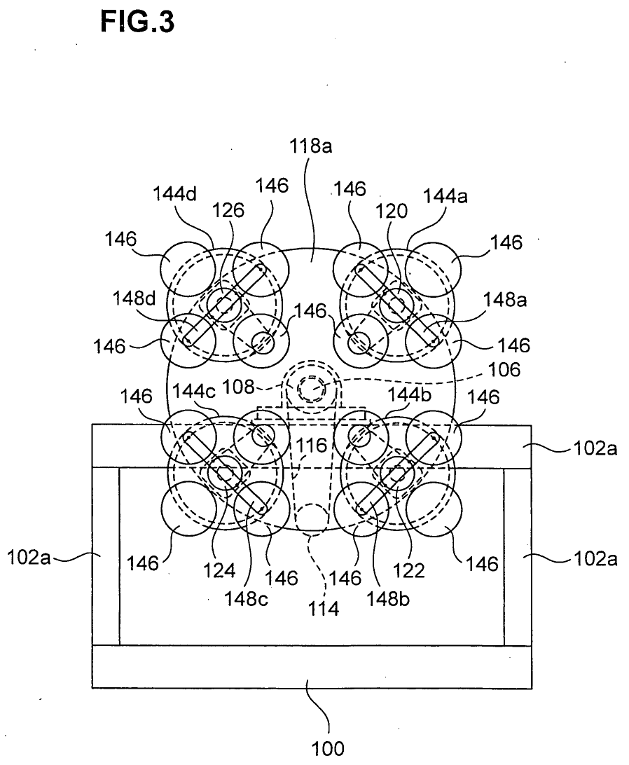

In the sample warper 200 of the present invention, the multi-shaft rotary creel with a novel structure is adopted, which will be explained below. As shown in FIG. 2 and FIG. 3, the multi-shaft rotary creel 206 has a base body 100, and a front frame 102a and a rear frame 102b are mounted opposing to each other on an upper surface of the base body 100 in a standing manner. Incidentally, in FIG. 2, reference numeral 107 denotes a slip ring provided on a surface of a main shaft 106.

A pair of front and rear bearings 104a, 104b for the main shaft 106 are provided on upper portions of the front frame 102a and the rear frame 102b, respectively. The main shaft 106 is rotatably mounted via the main shaft bearings 104a and 104b. The main shaft 106 is provided such that the front end side thereof is projected ahead of the front frame 102.

A main shaft counter pulley 108 is provided at a rear end portion of the main shaft 106 protruding rearward from the rear main shaft bearing 104b. Reference numeral 110 denotes a main shaft motor, which is disposed at a suitable portion of the rear frame 102b. A main shaft motor axis 112 protrudes at a rear end portion of the main shaft motor 110, and the main shaft motor axis 112 is provided with a main shaft motor pulley 114. The main shaft counter pulley 108 and the main shaft motor pulley 114 are coupled with a main shaft belt 116. Therefore, by driving the main shaft motor 110, its driving force is transmitted to the main shaft 106 via the main shaft motor axis 112, the main shaft motor pulley 114, the main shaft belt 116 and the main shaft counter pulley 108, whereby the main shaft 106 is rotated. In this connection, as the main shaft motor 110, a servomotor may be used. Further, it is preferable that when toothed pulleys are used as the main shaft counter pulley 108 and the main shaft motor pulley 114 and a toothed belt is used as the main shaft belt 116, the main shaft counter pulley 108 and the motor pulley 114 can be coupled in a state that no slip occurs therebetween.

A pair of front and rear supporting plates 118a and 118b are provided opposing to each other at a projecting portion 106a of the main shaft 106 projecting forward from the front main shaft bearing 104a. Plural (four in this embodiment, namely, first to fourth) supporting shafts 120, 122, 124 and 126 are rotatably mounted between the supporting plates 118a and 118b via front or rear supporting shaft bearings 128a, 128b, 130a, 130b, 132a, 132b, and 134a, 134b (only the shaft bearings 128a, 128b, and 130a, 130b are illustrated in FIG. 2) so as to be positioned radially about the projecting portion 106a of the main shaft 106. In this connection, reference numeral 127 in FIG. 2 denotes each of slip rings provided on a surface of the supporting shafts 120, 122, 124 and 126.

Supporting shaft counter pulleys 136a, 136b, 136c and 136d are provided at rear end potions of the supporting shafts 120, 122, 124 and 126 projecting rearward from the rear bearings 128b, 130b, 132b and 134b. Reference numerals 138a, 138b, 138c and 138d denote supporting shaft motors, which are provided at suitable portions of the rear supporting plates 118b. Supporting shaft motor axes are protruded at rear end portions of the supporting shaft motors 138a, 138b, 138c and 138d, and the supporting shaft motor axes are provided with supporting shaft motor pulleys 140a, 140b, 140c and 140d. The supporting shaft counter pulleys 136a, 136b, 136c and 136d and the supporting shaft motor pulleys 140a, 140b, 140c and 140d are coupled with supporting shaft belts 142a, 142b, 142c and 142d. Therefore, by driving the supporting shaft motors 138a, 138b, 138c and 138d, their driving forces are transmitted to the supporting shafts 120, 122, 124 and 126 via the supporting shaft motor axes, the supporting shaft motor pulleys 140a, 140b, 140c and 140d, the supporting shaft belts 142a, 142b, 142c and 142d, and the supporting shaft counter pulleys 136a, 136b, 136c and 136d, whereby the supporting shafts 120, 122, 124 and 126 are rotated. In this connection, as the supporting motors 138a, 138b, 138c and 138d, servomotors may be used. It is preferable that, when toothed pulleys are used as the counter pulleys 136a, 136b, 136c and 136d and the motor pulleys 140a, 140b, 140c and 140d, and toothed belts are used as the supporting shaft belts 142a, 142b, 142c and 142d, the counter pulleys 136a to 136d and the motor pulleys 140a to 140d are coupled in a state that no slip occurs therebetween.

Annular bobbin holders 144a, 144b, 144c and 144d are fixed to distal end portions of the supporting shafts 120, 122, 124 and 126 projecting forward from the front supporting shaft bearings 128a, 130a, 132a and 134a. Plural (four in this embodiment) bobbins 146 are mounted on each of the bobbin holders 144a, 144b, 144c and 144d, respectively. Different kinds and/or the same kind of yarns 22 have been wound on the bobbins 146. Therefore, supply or suspension of the yarns 22 can be performed by suitably combining rotating or suspending state of the main shaft 106 and rotating or suspending state of the supporting shafts 120, 122, 124 and 126. In FIG. 2, such a situation is shown that yarns 22m from the bobbins 146 held by the bobbin holder 144a provided on the distal end portion of the first supporting shaft 120 are in a warping state, i.e., the yarns 22m are caught by the yarn guides 6a to 6h to be wound on the warper drum 202, while the yarns 22n from the bobbins 146 held by the bobbin holder 144b provided on the distal end portion of the second supporting shaft 122 are in a suspending state, i.e., the yarns 22n are stored in the yarn selection device 27.

Reference numerals 148a, 148b, 148c and 148d denote guide plates, which serve to guide the plural yarns 22 not to get tangled. The structure of each of the guide plates 148a to 148d is not limited to a specific one, but rod shaped one is shown in the illustrated embodiment. Incidentally, in a general structure of the rotary creel, as shown in JP2002-339183A, a yarn reserving device and a yarn returning device are disposed between the bobbins and the guide plate, but they are omitted in the embodiment shown in FIG. 2. With such a structure, plural yarns 22 which have been wound on plural bobbins 146 respectively are guided through the yarn reserving device, the yarn returning device and guide plates 148 and the yarns 22m to be warped are introduced to the yarn guides 6a to 6h, whereby the yarns 22m are wound on the warper drum 202. On the other hand, the suspending yarns 22n are guided through the yarn reserving devices, the yarn returning devices and the guide plates 148, and then the yarns 22n are introduced to the yarn selection device 27 and stored therein.

Various warping methods can be employed using the multi-shaft rotary creel of the present invention, which will be explained below.

(1) Simultaneous warping of a plurality of yarns is performed using all bobbins (sixteen bobbins in the illustrated embodiment) 146 under the following conditions. The main shaft 106 is rotated in synchronism with rotation of the yarn guides 6a to 6b of the sample warper and each of the supporting shafts 120, 122, 124 and 126 is rotated to positions such that the guide plates 148a to 148d forms a shape approximating to a circle shown in FIG. 3, then suspended at the positions and the suspended state of each of the supporting shafts 120, 122, 124 and 126 is kept. All bobbins 146 held by the bobbin holders 144a, 144b, 144c and 144d provided on the suspended supporting shafts 120, 122, 124 and 126 are used for warping. By employing such warping, the yarns 22 are pulled out smoothly, which is convenient.

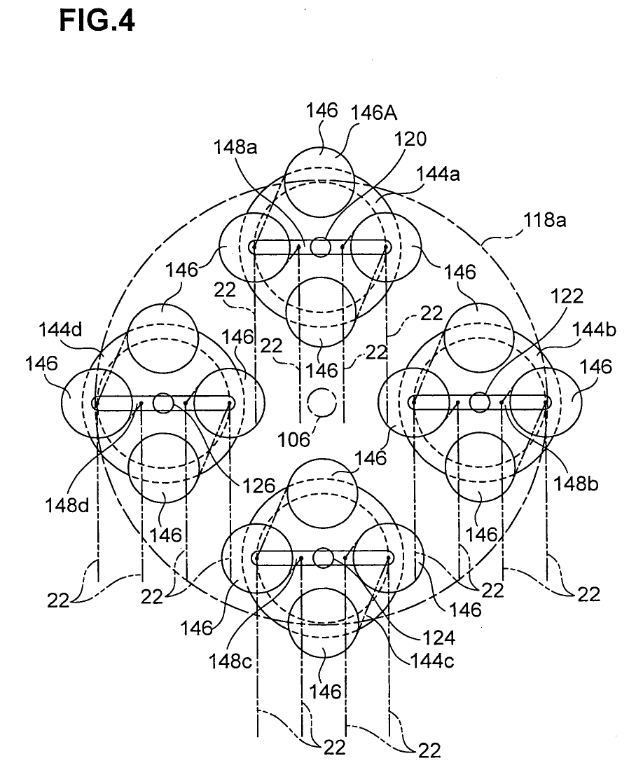

(2) Simultaneous warping of a plurality of yarns using four bobbins 146 held by the bobbin holder 144a provided on one of the supporting shafts, for example, the supporting shaft 120 is performed under the following conditions. First, the main shaft 106 is rotated such that the supporting shaft 120 to be used for warping is moved to a close position vertically above an extension line of the center position of the front face of the warper drum 202, that is to say, the bobbin holder 144a to be used for warping is moved to the highest position. In this state, the suspended position of the main shaft 106 is kept and the supporting shaft 120 to be used for warping is rotated in synchronism with rotation of the yarn guides 6a to 6h of the sample warper 200, and the remaining supporting shafts 122, 124 and 126 are rotated to their horizontal positions shown in FIG. 4, then suspended at the positions and the suspended state is kept for warping. In this case, four bobbins 146 held by the bobbin holder 144a are rotated according to rotation of the supporting shaft 120, so that warping is performed using four yarns. Therefore, in case where various kinds of yarns are warped according to various warping conditions, if different kinds or different colors of yarns 22 are set as the yarns 22 of the bobbins 146 held by the four bobbin holders 144a to 144d, respectively, various kinds of yarns 22 can be warped by sequentially rotating the supporting shafts 120, 122, 124 and 126 to a warping position (the highest position in FIG. 4).

(3) Single yarn warping is performed using one bobbin 146 under the following conditions. The main shaft 106 is rotated such that the supporting shaft (indicated by reference numeral 120 in the embodiment shown in FIG. 4) supporting the bobbin 146 to be used for warping is positioned at a close position vertically above the extension line of the center position of the front face of the warper drum 202, then suspended at the positions and the suspended state is kept for warping. Next, the supporting shaft 120 is rotated such that a bobbin (indicated by reference numeral 146A in FIG. 4) of the four bobbins 146 on which a yarn for single yarn warping has been wound held by the bobbin holder 144a is moved to the highest position. In this state, all the supporting shafts 120, 122, 124 and 126 are suspended and the suspended positions are kept. Single yarn warping is performed using the bobbin 146A positioned at the highest position. Accordingly, when single yarn warping of different kinds or different colors is performed, such single yarn warping can be performed by sequentially moving the bobbins on which the yarns of different kinds or different colors have been wound to the highest position in the same procedure as the above one.

In the illustrated embodiment, there is shown the example where one multi-shaft rotary creel 206 is installed opposing to the sample warper 200, but the multi-shaft rotary creel 206 may be combined with a fixed creel, as shown in JP2000-136456A and EP933455A2, and a plurality of the multi-shaft rotary creels 206 may be installed, as shown in JP2002-339183A.

Further, in the illustrated embodiment, there is shown the example where the multi-shaft rotary creel of the present invention is applied to the sample warper 200 provided with the yarn selection device 27 in which pattern warping is performed by winding yarns on the warper drum 202 while exchanging yarns. However, as a matter of course, the multi-shaft rotary creel of the present invention may be applied to a sample warper where yarns are wound on the warper drum 202 by performing winding and suspension of yarns alternately to perform pattern warping without installing the yarn selection device 27, as shown in, for example, Japanese Patent No. 3263050 and JP2002-212851A.

1. A multi-shaft rotary creel comprising: a base body; a main shaft rotatably mounted on the base body so as to project forward; a plurality of supporting shafts rotatably mounted on a forward projecting portion of the main shaft; and a plurality of bobbins mountable on each of the supporting shafts, which is installed opposing to a sample warper with a plurality of yarn guides, and wherein, while the main shaft or each of the supporting shafts rotates in synchronism with rotation of the yarn guides, simultaneous warping of plural yarns by the main shaft or each of the supporting shafts can be performed.

2. The multi-shaft rotary creel according to claim 1, further comprising a driving unit for performing rotation and suspension of the main shaft and each of the supporting shafts and serving to keep suspended positions thereof.

3. A sample warper comprising: a warper drum; and a plurality of yarn guides each rotatably mounted on a side surface of the warper drum for winding yarns on the warper drum, wherein yarns are wound on the warper drum according to a preset yarn order, and wherein there is installed the multi-shaft rotary creel according to claim 1 having a plurality of bobbins on which different kinds and/or the same kind of yarns have been wound.

4. A sample warper comprising: a warper drum; and a plurality of yarn guides each rotatably mounted on a side surface of the warper drum for winding yarns on the warper drum, wherein yarns are wound on the warper drum according to a preset yarn order, and wherein there is installed the multi-shaft rotary creel according to claim 2 having a plurality of bobbins on which different kinds and/or the same kind of yarns have been wound.

5. A warping method using the sample warper according to claim 3 or 4, wherein in a state that each of the supporting shafts keeps a suspended position thereof the main shaft is rotated in synchronism with rotation of the yarn guides to perform simultaneous warping of plural yarns using all the bobbins.

6. A warping method using the sample warper according to claim 3 or 4, wherein one of the plural supporting shafts is rotated in synchronism with rotation of the yarn guides to perform simultaneous warping of plural yarns using a plurality of bobbins mounted on the one supporting shaft.

7. A warping method using the sample warper according to claim 3 or 4, wherein the main shaft and each of the supporting shafts are suspended and single yarn warping is performed using any one of the bobbins of the multi-shaft rotary creel.
